(19) United States
(12) Patent Application Publication
(10) Pub. No.: US 2005/0245713 A1
(43) Pub. Date: Nov. 3, 2005

(54) Method for producing polymers

(75) Inventors: Thomas Daniel, Waldsee (DE); Ulrich Riegel, Frankfurt (DE); Mark Elliott, Ludwigshafen (DE)

Correspondence Address: MARSHALL, GERSTEIN & BORUN LLP, 233 S. WACKER DRIVE, SUITE 6300, SEARS TOWER, CHICAGO, IL, 60606, US

(73) Assignee: BASF AKTIENGESELLSCHAFT, Ludwigshafen (DE)

(21) Appl. No.: 10/521,292

(22) PCT Filed: Jul. 18, 2003
(86) PCT No.: PCT/EP03/07872

§ 371 Date: Jan. 11, 2005

(30) Foreign Application Priority Data
Jul. 30, 2002 (DE) 102 34 772.7

(51) Int. Cl. C08F 118/02

(52) U.S. Cl. 526/319

(57) ABSTRACT

A process for producing sodium acrylate polymers by free-radical polymerization of sodium acrylate with or without other monomers in an aqueous medium, which comprises using sodium acrylate in the form of an aqueous solution or dispersion obtainable by dissolving or dispersing solid sodium acrylate in an aqueous medium. The polymers thus obtainable have an improved color number and a lower residual monomer content than conventional comparable polymers.

The present invention relates to a process for producing sodium acrylate polymer in an aqueous medium.

The production of sodium acrylate is known. For instance, by the teaching of GB-C-1,073,856, a solution of sodium hydroxide in methanol is mixed with a solution of acrylic acid in methanol within the temperature range 5 to 50° C. It is preferable to add the sodium hydroxide solution in methanol to the acrylic acid solution. The sodium acrylate which forms is precipitated from the solution and can be centrifuged or filtered off. The solid sodium acrylate can be dried, preferably at a temperature below 40° C.

EP-B-0 372 706 discloses a method for the production of salts of acrylic acid by neutralization of acrylic acid with a basic compound in an aqueous medium by adding acrylic acid and a basic compound to water and initially adjusting the degree of neutralization of the acrylic acid to 75-100 mol %, then adding further basic compound to raise the degree of neutralization to 100.1-110 mol %, aging the reaction mixture at this degree of neutralization for 1 minute to 120 minutes and subsequently adding sufficient acrylic acid for the degree of neutralization of the acrylic acid to be in the range from 20 to 100 mol %. The thus obtainable aqueous solutions of partially or fully neutralized acrylic acid are used in the presence of crosslinkers to produce crosslinked polyacrylates which have a lower residual monomer content than polymers obtainable by polymerization of acrylates which have not been treated with an excess of neutralizing agent.

Commercial grade acrylic acid generally contains at least one stabilizer to control premature polymerization. When stabilized acrylic acid is polymerized, for example to produce superabsorbent polymers by the method disclosed in the above-cited reference, colored products are obtained. To produce colorless superabsorbents, stabilized acrylic acid must first be distilled or the stabilizer removed from the acrylic acid by absorption, for example onto activated carbon, and the acrylic acid polymerized ideally without delay.

It is an object of the present invention to provide a polymerization process whereby the polymers obtained are colorless and also have a lower residual monomer content than polymers preparable from stabilizer-containing acrylic acid.

We have found that this object is achieved according to the present invention by a process for producing sodium acrylate polymer by free-radical polymerization of sodium acrylate with or without other monomers in an aqueous medium, which comprises using sodium acrylate in the form of an aqueous solution or dispersion obtainable by dissolving or dispersing solid sodium acrylate in an aqueous medium.

Sodium acrylate in solid form has been described in the literature, but has hitherto not been used for producing polymers. Sodium acrylate polymers have hitherto always been produced from aqueous sodium acrylate solutions produced—usually directly prior to the polymerization—by neutralizing pure acrylic acid or stabilizer-containing acrylic acid with aqueous sodium hydroxide solution. Since pure acrylic acid is not stable, it had to be neutralized with aqueous sodium hydroxide solution directly after the distillation or after a fractional crystallization. Solid sodium acrylate is sufficiently stable for it to be stored and transported for a prolonged period without stabilization against polymerization. Sodium acrylate should be stored and transported at not more than 40° C. The storage and transportation temperatures are usually in the range of, for example, from 5 to 35° C. and especially from 10 to 20° C.

Solid sodium acrylate may have an average particle diameter from 45 μm to 2 000 μm and preferably from 45 μm to 500 μm. The aqueous monomer solutions are preferably produced from anhydrous sodium acrylate. The solid pulverulent sodium acrylate, which is hygroscopic, may however also contain for example from 0.1% to 10% by weight and especially from 0.5% to 2% by weight of water. When solid sodium acrylate is heated, the solid salt is virtually unaltered at up to 250° C.; on the contrary, it will not decompose until above this temperature, in the course of melting.

Solid sodium acrylate is very readily soluble in water. Solid sodium acrylate can be used to prepare aqueous monomer solutions or aqueous dispersions that in either case contain for example from 5% to 75% and preferably from 20% to 45% by weight of sodium acrylate. When the sodium acrylate concentration is more than 45% by weight, the system is a dispersion of sodium acrylate. These solutions or dispersions can be directly polymerized. In the polymerization of aqueous sodium acrylate dispersions, the sodium acrylate dissolved in the water will react first, while the dispersed sodium acrylate will dissolve in the course of the polymerization. If appropriate, however, acrylic acid may be added to these solutions as well, providing a partially neutralized acrylic acid having a degree of neutralization of for example from 10 to 95 mol %, preferably from 40 to 90 mol % and especially from 60 to 80 mol %.

The aqueous monomer solutions or dispersions prepared by dissolving or dispersing solid sodium acrylate with or without acrylic acid in water may optionally contain further water-soluble comonomers, for example methacrylic acid, maleic acid, itaconic acid, 2-acrylamido-2-methylpropanesulfonic acid, alkali metal and ammonium salts and also amides of the acids mentioned, hydroxyalkyl esters of acrylic acid or methacrylic acid, N-vinylformamide and diallyldimethylammonium chloride. The aqueous monomer solutions of sodium acrylate which are to be used according to the present invention may also be copolymerized with water-insoluble monomers such as styrene and/or (meth)acrylic esters of monohydric alcohols, for example n-butyl acrylate, tert-butyl acrylate or isobutyl acrylate, acrylonitrile, methacrylonitrile and/or vinyl esters such vinyl acetate or vinyl propionate. This provides aqueous dispersions or—depending on the amount of water-soluble monomers used in the copolymerization—aqueous polymer solutions of hydrophobically modified polymers.

In the preferred version of the process, the acrylate solution is admixed with acidic comonomers such as, for example, acrylic acid prior to the polymerization.

According to the present invention, the solid sodium acrylate can also be wholly or partly replaced by another solid water-soluble salt, for example by potassium acrylate or by alkaline earth metal acrylates such as in particular magnesium acrylate, strontium acrylate or barium acrylate. Similarly, mixtures of the contemplated solid alkali metal and alkaline earth metal acrylates can be polymerized.

The aqueous monomer solutions or dispersions of sodium acrylate with or without acrylic acid which are to be used according to the present invention are preferably used for producing water-insoluble crosslinked polymer gels. Such polymer gels are obtained when the aqueous solutions of sodium acrylate which are to be used according to the present invention are polymerized in the presence of from 0.001% to 5% by weight and preferably from 0.01% to 2% by weight of a monomer containing at least two ethylenically unsaturated double bonds. Examples of suitable crosslinkers are N,N′-methylenebisacrylamide, diacrylates or dimethacrylates of polyalkylene glycols having molar masses from 100 to 1 500, trimethylolpropane trimethacrylate, at least doubly acrylated or methacrylated reaction products of trimethylolpropane having from 1 to 8 mol of ethylene oxide per OH group, especially the fully acrylated or methacrylated reaction products of trimethylolpropane having from 2 to 6 mol of ethylene oxide per OH group, triallylamine or tetraallylammonium chloride. Processes for producing crosslinked polymer gels are known for example from pages 6 and 7 of the prior art citation EP-B-0 372 706 and also from pages 4 to 8 of WO-A-99/42494 and also from WO 01/38402. The products are particulate hydrogels which have an average particle diameter of for example from 45 to 1 000 μm, preferably from 150 to 850 μm and more preferably <700 μm.

To produce particulate hydrogels having a high gel strength, the particulate hydrogels are subjected to a surface postcrosslinking operation. Examples of suitable surface postcrosslinkers are polyhydric alcohols, cf U.S. Pat. No. 4,666,983, and also 2-oxazolidinones, cf WO-A-99/42494. The postcrosslinking of particulate hydrogels is extensively described in the references mentioned. The particulate hydrogels are typically sprayed with a solution of at least one crosslinker in an inert solvent such as water or mixtures of water with a monohydric or polyhydric alcohol. To effect surface postcrosslinking, the hydrogel particles which have been treated with a solution of the crosslinker are heated to a temperature in the range from 50 to 250° C. and preferably from 115 to 190° C.

When solid sodium acrylate is used in accordance with the present invention for producing aqueous monomer solutions, the eventual products are polymers which, compared with the particulate hydrogels obtained according to existing processes, have an improved color number and a lower residual acrylic acid monomer content.

The salts of acrylic acid are stable in the solid state as well as in aqueous solution, so that no diacrylic acid is formed in the course of the storage of solid salts and of aqueous solutions of the salts. Polymers which are prepared from these monomers can be heated to higher temperatures, for example to 190-210° C., without increasing the residual level of acrylic acid in the polymer. When, in contrast, acrylic acid which contains diacrylic acid is polymerized, the units in the resulting polymer which are derived from diacrylic acid are observed to cleave back to acrylic acid on heating of the polymer. This is why such polymers have a higher residual monomer content after being subjected to a thermal stress than before. Nor does sodium acrylate need to be stabilized against premature polymerization by addition of inhibitors.

For instance, the particulate hydrogels obtained after surface crosslinking have a DIN 5033 color number of L≧90 and also a color number of b<10, and it is preferable for L to be ≧93 and b to be <8.

The Saline Flow Conductivity (SFC) values of the surface-postcrosslinked particles are for example >25, preferably >60 and especially >100. The residual acrylic acid content of the particulate hydrogels which have been subjected to a surface postcrosslinking operation is for example <500 ppm and preferably <300 ppm. These particles have a Centrifuge Retention Capacity (CRC) value from 20 to 35 g/g.

Methods of Measurement

The 16 h extractables were determined as per ISO/DIS 17190-10. SFC (Saline Flow Conductivity) was determined by the test method reported in U.S. Pat. No. 5,599,335.

CRC (Centrifuge Retention Capacity) and AUL (Absorption Under Load) were determined as prescribed on pages 8 and 9 of WO-A-99/42494.

The color numbers were determined in accordance with DIN 5033 (see also Richard S. Hunter, The Measurement of Appearance, Wiley Ny 1975). A Hunterlab S 5100 colorimeter was used.

The percentages in the examples are by weight.

### COMPARATIVE EXAMPLE 1

14.24 kg of 50% aqueous sodium hydroxide solution were introduced into a plastic drum having an internal heat exchanger as initial charge and were incrementally neutralized with 17.08 kg of acrylic acid having a 200 ppm hydroquinone monomethyl ether stabilizer content with cooling. At the same time, 28.68 kg of completely ion-free water were added a little at a time to dilute the reaction solution. All the while the temperature was maintained below 40° C.

The partially neutralized solution was admixed with 103 g of the diacrylate of polyethylene glycol of molar mass 400 (Sartomer SR 344). The solution was then inertized by passing nitrogen gas into it until the oxygen content of the reaction mixture was <2 ppm. 427 g of 10% aqueous sodium persulfate solution were then mixed in. The reaction solution was then poured under a stream of nitrogen into a foil- or film-covered pan resting on a flat surface so that the layer was about 6 cm deep everywhere. At the same time as the reaction solution was poured into the pan, the following initiator solutions were pumped in at a uniform rate: 85 g of 10% aqueous solution of 2,2′-azobis(2-methylpropionamidine) dihydrochloride (V-50, Wako), 342 g of 2.5% by weight hydrogen peroxide solution and 102 g of 2.5% by weight ascorbic acid solution.

The polymerization ensued within a few minutes. After the temperature had peaked, the gel was left to age in the pan for 4 hours. It was then cut into pieces, comminuted by means of a commercially available meat mincer into a finely crumbled gel and dried on trays in a circulating air cabinet at 160° C. for 3 h.

The dried superabsorbent cake was then mechanically comminuted, ground on a roll mill and sieved to remove everything but the 300-850 μm fraction. This fraction was used for the rest of the tests. The particulate superabsorbent (base polymer) had the following typical properties: CRC=37 g/g, extractable fractions after 16 h of aging in 0.9% sodium chloride solution=9.9%, residual acrylic acid monomer=390 ppm.

A portion of this fraction was postcrosslinked with 2-oxazolidinone as per WO 99/42494 by spraying the superabsorbent granules homogeneously with a mixture of 0.10% of 2-oxazolidinone, 1.47% of isopropanol and 3.43% of completely ion-free water (weight percentages are each based on superabsorbent to be crosslinked). This material was subsequently annealed at 185° C. in a circulating air cabinet for 60 min. The thus obtained surface-postcrosslinked particulate hydrogel had the following properties:
CRC=30-31 g/g
AUL 0.7 psi=25-26 g/g
SFC=25-35
Residual acrylic acid monomer=570 ppm
Color numbers L=84/a=−0.6/b=15

### INVENTIVE EXAMPLE 1

The comparative example was repeated except that the initial charge contained 4.27 kg of acrylic acid and 16.73 kg of solid sodium acrylate salt and also 39 kg of completely ion-free water were added a little at a time. The mixture was intensively stirred until a completely homogeneous solution had formed. The temperature was maintained in the range of 20-40° C. The monomer solution thus prepared was then polymerized as prescribed in the comparative example.

The base polymer (particle size from 300 to 850 μm) had the following properties: CRC=37.5 g/g, extractable fractions after 16 h of aging in 0.9% sodium chloride solution=9.7%, residual acrylic acid monomer=320 ppm.

The particulate base polymer was subsequently subjected to a surface postcrosslinking operation as described in the comparative example. The particulate hydrogel obtained had the following typical properties:
CRC=30-31 g/g
AUL 0.7 psi=25-26 g/g
SFC=25-35
Residual acrylic acid monomer=380 ppm
Color numbers L=92/a=−0.4/b=7

1. A process for producing a sodium acrylate polymer by a free-radical polymerization of sodium acrylate with or without other monomers in an aqueous medium, which comprises using sodium acrylate in a form of an aqueous solution or dispersion obtainable by dissolving or dispersing solid sodium acrylate in the aqueous medium.

2. The process of claim 1 wherein the aqueous solution of sodium acrylate contains from 10 to 100 mol % of sodium acrylate and from 0 to 90 mol % of acrylic acid.

3. The process of claim 1 wherein the aqueous solution of sodium acrylate contains from 10 to 95 mol % of sodium acrylate and from 5 to 90 mol % of acrylic acid.

4. The process of claim 1 wherein the aqueous solution of sodium acrylate contains from 40 to 90 mol % of sodium acrylate and from 10 to 60 mol % of acrylic acid.

5. The process of claim 1 wherein the aqueous solution contains from 0.01 to 5 mol % of a monomer containing at least two ethylenically unsaturated double bonds.

6. The process of claim 1 wherein the aqueous monomer solution is prepared using solid anhydrous sodium acrylate.

7. The process of claim 1 wherein the solid sodium acrylate has a water content from 0.1% to 10% by weight.

8. A sodium acrylate polymer prepared by the process of claim 1.

9. A method of producing a polymer from solid sodium acrylate comprising dissolving the solid sodium acrylate in water to form an aqueous monomer solution and polymerizing the monomer solution in the presence or absence of other monomers.

10. The process of claim 1 wherein the solid sodium acrylate is wholly or partly replaced by another water-soluble salt of acrylic acid.
